(19) United States
(12) Patent Application Publication
(10) Pub. No.: US 2009/0092952 A1
(43) Pub. Date: Apr. 9, 2009

(54) Apparatus for Touch-Sensitive Visual and Audible Identification

(76) Inventors: Irene Schlanger, Upper Nyack, NY (US); Steven Schlanger, Upper Nyack, NY (US); Paul Contino, Huntington, NY (US)

Correspondence Address: F. CHAU & ASSOCIATES, LLC, 130 WOODBURY ROAD, WOODBURY, NY, 11797, US

(21) Appl. No.: 11/869,331

(22) Filed: Oct. 9, 2007

(51) Int. Cl. G09B 5/06

(52) U.S. Cl. 434/169

(57) ABSTRACT

An apparatus for visual and audible identification includes a display region for displaying a written name of an object. A speaking module pronounces a spoken name of the object when activated. An activation switch activates the speaking module. An attachment unit couples the apparatus to the object.

### BACKGROUND OF THE INVENTION

1. Technical Field

The present disclosure relates to audible identification and, more specifically, to an apparatus for touch-sensitive visual and audible identification.

2. Discussion of the Related Art

The development of one's ability to read is predicated on the acquisition of five fundamental skills areas: phonemic awareness, phonetic knowledge, fluency, comprehension, and vocabulary. Without sufficient strength in any one of these components, one's ability to read can be adversely affected. To build vocabulary, teachers and parents have for years created lists of words, often called “sight words,” to familiarize emerging readers with a foundation of readily identified vocabulary that upon being heard or recognized, yield instant recall of sound and meaning. The sight words are an essential part of a scaffold of reading skills and strategies that continue and expand with practice. Additionally, the more extensive one's knowledge of language becomes over time, the more proficient and articulate one becomes when using language to communicate.

To develop reading skills, parents and teachers may use signs and tags to display the written name of an object on the object itself. For example, a table may be tagged with the word, “table” and each chair may be tagged with the word, “chair.” Thus when the learner encounters the labeled object, a connection may be formed, in the mind of the learner, between the physical object and its written name.

While such an approach may develop a connection between object and written name in the mind of the learner, the learner is not able to encounter the pronunciation of the word and thus there is no opportunity to develop a three-way connection, in the mind of the learner, between the physical object, its written name and the pronunciation of the name.

### SUMMARY

An apparatus for visual and audible identification includes a display region for displaying a written name of an object. A speaking module pronounces a spoken name of the object when activated. An activation switch activates the speaking module. An attachment unit couples the apparatus to the object.

The display region may include a handwriting surface upon which a user may hand-write the written name of the object. The handwriting surface may be a dry-erase surface upon which a dry erasable marker may be used. The display region may include an electronic display device.

The speaking module may be programmed by a user by recording the voice of the user pronouncing the spoken name of the object.

The activating switch may include a touch-sensitive button. The activation switch may include a proximity sensor.

The attachment unit may include a stand for standing the apparatus on the object. The attachment unit may include an adhesive layer for adhering the apparatus to the object. The attachment unit may include a Velcro layer for affixing the apparatus to a complementary Velcro layer attached to the object. The attachment unit may include a magnetic unit for attaching the apparatus to a metallic portion of the object.

The apparatus may additionally include a memory storage unit for storing one or more written names of objects to be displayed on the display region. The apparatus may additionally include one or more corresponding spoken names of the objects to be pronounced by the speaking module when activated.

The display region may be a first display region for displaying a written name of the object in a first language. The apparatus may additionally include a second display region for displaying a written name of the object in a second language.

A body of the apparatus may be primarily comprised of a laminated paper stock that functions as the display region and includes a handwriting surface upon which a user may hand-write the written name of the object.

An apparatus for visual and audible association includes a database for storing a plurality of words along with corresponding definitions of the words and associated difficulty levels. The apparatus additionally includes a difficulty switch that may be set into a plurality of states representing a desired word difficulty level. A processing unit selects a word from the database based on the state of the difficulty switch. A display device displays the selected word when activated. A speaking module pronounces the selected word when activated. An activation switch activates the display device and the speaking module.

The display device may additionally display the corresponding definition of the selected word when activated. The speaking module may additionally pronounce the corresponding definition of the selected word when activated.

The difficulty switch may be an analog switch that may be set to any position within a continuous range. The difficulty switch may be a multi-level toggle switch, a dial switch or a slider switch. The selection of the selected word from the database may include reading the state of the difficulty switch and selecting the selected word based on a degree of similarity between the state of the difficulty switch and the associated difficulty level of the words stored in the database. The probability of a particular word being selected may increase as the degree of similarity between the state of the difficulty switch and the associated difficulty level of the particular word being selected increases.

A method for teaching an association between an object and a written name of the object includes displaying the written name of the object within a display region of an apparatus. The apparatus is coupled to the object by an attachment unit. The object and coupled apparatus are presented to an observer who simultaneously observes the object and the displayed written name of the object on the apparatus.

A speaking module may be activated to pronounce a spoken name of the object. Displaying the written name of the object within the display region of an apparatus may include hand-writing the written name of the object on a handwriting surface of the display region. A speaking module of the apparatus may be programmed by recording a pronunciation of a spoken name of the object prior to presenting the object and coupled apparatus to the observer. The speaking module may be activated to replay the recorded pronunciation of the spoken name of the object after presenting the object and coupled apparatus to the observer.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a perspective front view of an apparatus for touch-sensitive visual and audible identification according to an exemplary embodiment of the present invention;

FIG. 2 is a perspective back view of the apparatus for touch-sensitive visual and audible identification of FIG. 1;

FIG. 3 is a perspective front view of an apparatus for touch-sensitive visual and audible identification according to an exemplary embodiment of the present invention; and

FIG. 4A is a front view of an apparatus for touch-sensitive visual and audible identification according to an exemplary embodiment of the present invention; and

FIG. 4B is a back view of the apparatus of FIG. 4A.

### DETAILED DESCRIPTION OF THE DRAWINGS

In describing the exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Exemplary embodiments of the present invention provide an inexpensive and highly portable device for establishing a three-way association between a physical object, the written name of the object and the pronunciation of the name of the object. The device may be an apparatus that is readily attachable to a physical object. The apparatus may include a touch-sensitive control that may be actuated to initiate a recordable audible identification and a visual display for displaying a written identification.

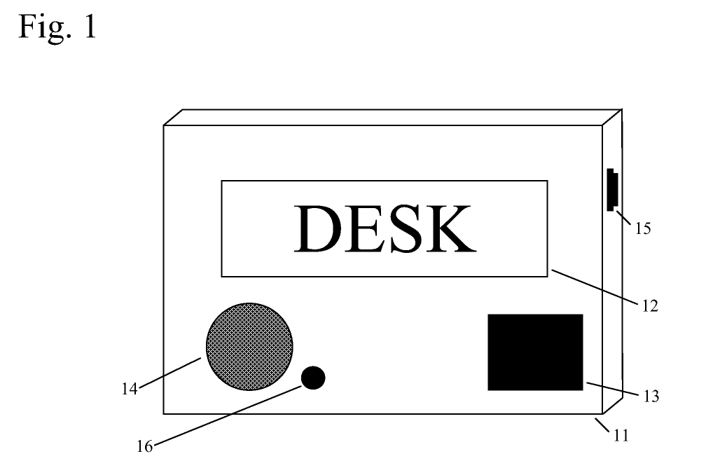

FIG. 1 is a perspective front view of an apparatus for touch-sensitive visual and audible identification according to an exemplary embodiment of the present invention. The apparatus 11 may include a display region 12 for the display of a written identification, for example, the written name of an object the apparatus 11 is to be attached to or placed upon. The display region 12 may be of any size relative to the size of the apparatus 11. For example, the display region 12 may occupy a small surface of the apparatus 11 or alternatively, the display region 12 may occupy an entire front face of the apparatus 11. The display region 12 may be an electronic display panel such as an LCD, LED, or OLED panel. Alternatively, the display region 12 may be a writing surface such as a paper-covered writing surface that may be easily written to with a writing implement, for example, a pencil, pen or marker. The display region 12 may be an erasable writing surface, for example, a coated surface, which allows for the application and easy removal of an erasable marker, for example, a dry erase marker.

Where the display region 12 is a writing surface, a user may write, on the writing surface, the name of an object the apparatus 11 is to be coupled to. Where the display region 12 is an electronic display, the electronic display may be programmed with the name of the object by electronic input, for example, by pressing a sequence of buttons to scroll through letter selections, as if setting the time on a digital clock, or by connecting a removable keyboard device (not shown) for example, by a mini USB connection 15. Alternatively, the electronic display may be preprogrammed with a set of common object names that may be easily scrolled through and selected.

The display region 12 may additionally or alternatively be an area capable of receiving a pre-printed sticker or removable label. Thus a sheet of pre-printed stickers or labels having common object names printed thereon may be used to setup the display region 12 with the desired written name.

The apparatus 11 may also include an activation switch 13 for activating a speaking module 14. The activation switch 13 may be a touch-sensitive switch, for example, a push button, toggle switch, or drop switch. Alternatively, the activation switch 13 may be a touch sensor that may activate upon the slightest touch. According to one exemplary embodiment of the present invention, an entire outer casing of the apparatus 11 may be a touch sensor, for example, a capacitive touch sensor. According to one exemplary embodiment of the present invention, the activation switch 13 and the display region 12 may be comprised of a single touch-sensitive display device, for example, a touch-screen.

The activation switch 13 need not be touch-sensitive. For example, the activation switch 13 may be light-sensitive such as an electric eye. Accordingly, the activation switch 13 may be activated by close proximity of a user as detected by the electric eye. According to other exemplary embodiments, the activation switch 13 may be a sound-sensitive switch and may be activated by close proximity of a user as detected by sound. In fact, the activation switch 13 may be any manner of proximity sensor and/or touch sensor.

Upon activation of the activation switch 13, the speaking module 14 may pronounce a preprogrammed word. The speaking module 14 may thus be programmed to pronounce the name of the object that the apparatus 11 is to be coupled to, and this may be the same name that is written out on the display region 12.

The speaking module 14 may be fully programmable and may allow for a user to record the user's own voice while pronouncing the desired object name. The apparatus 11 may include a program button 16 that may be activated to initiate programming of the speaking module 14. Upon activating the program button 16, the user may speak into a microphone (not shown) to record the user's voice into the speaking module 14. The speaking module 14 may be re-recordable to record a new object name when desired.

Alternatively, the speaking module 14 may be preprogrammed with a set of common object names that may be scrolled through and selected. The process of selecting the desired name may coincide with the process for selecting the desired word for the electronic display, as described above.

An external device (not shown) may also be connected to the apparatus, for example, through the mini USB port 15 so that the selected and/or prerecorded word may be transferred to the speaking module 14 and/or the display region 12. The external device may be a general purpose computer running an application for the programming of the apparatus 11 or the external device may be a specific purpose device for programming the apparatus 11.

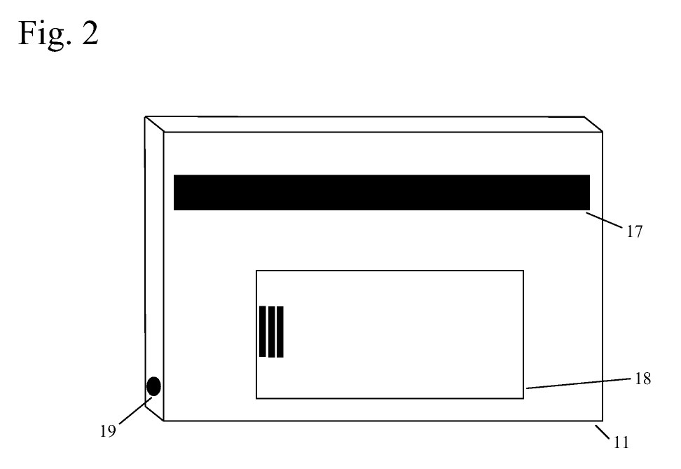

FIG. 2 is a perspective back view of the apparatus for touch-sensitive visual and audible identification of FIG. 1, and described above. It should be understood that features and elements illustrated in the front view of FIG. 1 are shown thereon for illustrative purposes only and features and elements illustrated in the back view of FIG. 2 are shown thereon for illustrative purposes only. Any of the features and elements may be located on any side of the apparatus 11.

The apparatus 11 may include an attachment unit 17 for coupling the apparatus 11 to the desired object. The attachment unit 17 may be a stand, base, adhesive pad, friction pad, magnet, snap, hook, Velcro strip, or any other desired unit for attaching the apparatus 11 to the desired object.

The apparatus may also include a battery compartment 18 for housing one or more batteries. The batteries may be used to power the speaking module 14 and/or the display region 12 if the display region 12 is an electronic display device. The batteries may also be used to power any other electronic feature of the apparatus 11. Where there is no battery compartment 18, batteries may be stored directly in the speaking module 14. The batteries may be replaceable or may be non-replaceable. The batteries may be rechargeable or may be single-use. Rechargeable batteries may be recharged with internal recharging circuitry that may accept power either from the mini USB port 15 or from a power connector 19. The apparatus may be powered directly from the power connector 19 to avoid the need for batteries.

Thus a first user, for example, a parent or teacher, may program, select, transfer, write or otherwise affix the written name of the desired object to the display region 12 and record, program, select, or transfer the spoken name of the object to the speaking module 14. The apparatus 11 may then be coupled to the desired object, for example, by the attachment unit 17. Then a second user, for example, a child and/or student (or perhaps the first user) may activate the apparatus 11 by triggering the activation switch 13, for example, by press, physical proximity and/or movement. Once triggered, the speaking module 14 may pronounce the spoken name of the object. If the display region 12 is an electric display panel, the electronic display panel may also be activated by the triggering. Accordingly, the second user is able to experience the physical object, the written name of the object and the spoken name of the object and thus form a lasting association.

In addition to, or as an alternative to teaching a child and/or student a primary language, exemplary embodiments of the present invention may be used to teach a child and/or student a secondary language. In such a case, the apparatus 11, may be set to display and pronounce the written name and spoken name of the desired object in two languages. For example, the display region 12 may display the written name of the desired object either in a second language or in both a first language and a second language and the speaking module 14 may pronounce the spoken name in either a second language or in both a first and a second language. Where the display region 12 is an electronic display device, the first-language written name and the second-language written name may be displayed either at the same time or one after the other.

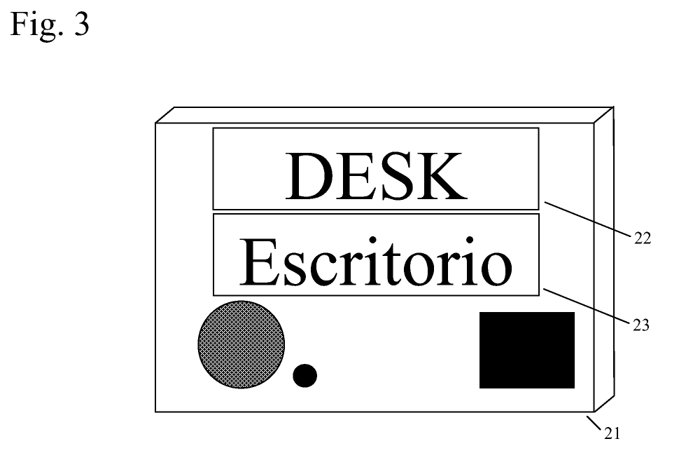

FIG. 3 is a perspective front view of an apparatus for touch-sensitive visual and audible identification according to an exemplary embodiment of the present invention. Here, the apparatus 21 includes a first display region 22 and a second display region 23 for displaying both a first-language written name and a second-language written name. The display regions 22 and 23 may be, for example, of the same type as any of the above-described display regions.

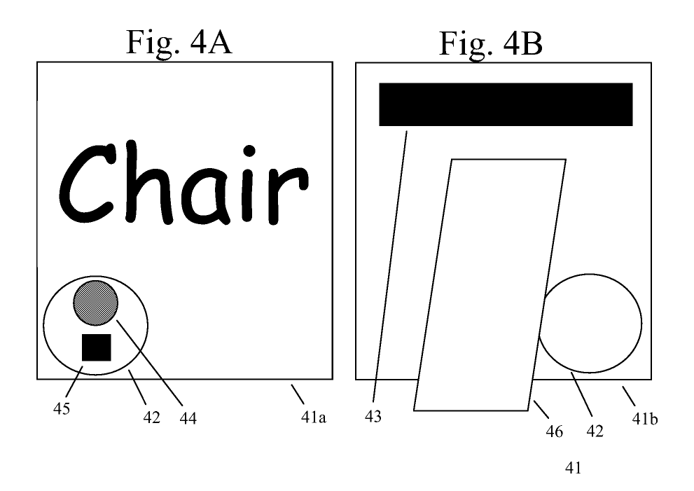

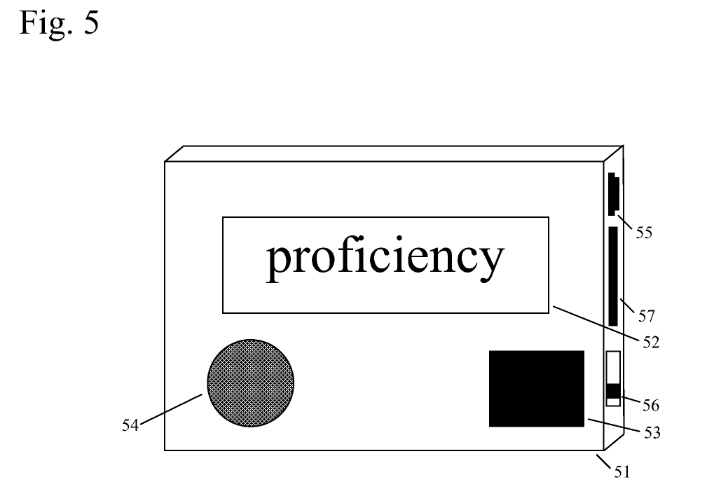

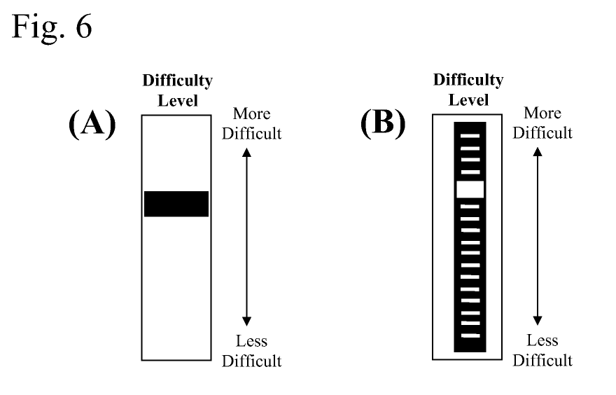

FIG. 4A is a front view of an apparatus for touch-sensitive visual and audible identification according to an exemplary embodiment of the present invention and FIG. 4B is a back view of the apparatus of FIG. 4A. The exemplary embodiment described below with reference to FIGS. 4A and 4B is an especially simple and low cost example of the device described more generally above.

Here, the apparatus 41 has a front face 41a and a back face 41b. The apparatus may be formed of a sturdy laminated paper stock, for example, measuring 8×10 inches. The laminated paper allows for the easy application and removal of a dry erase marker. A written name of a desired object may be written on the laminated paper, for example, on the front face 41a. A recordable sound module 42 may be embedded in the laminated paper. The recordable sound module 42 may include a speaking module 44 and an activation switch 45. The apparatus 41 may also include an attachment unit 43, for example, on the back side 41b. Alternatively, or additionally, the apparatus 41 may include a stand 46, for example, made out of sturdy paper stock. Either the attachment unit 43 or the stand 46 may be used as an attachment unit to couple the apparatus 41 to the desired object. The apparatus 41 may be coupled to the object either by affixing the apparatus 41 to the object or by placing the apparatus upon the object.

Exemplary embodiments of the present invention may additionally or alternatively be used as a tool to teach a child and/or student the definition of words. FIG. 5 is a perspective view of an apparatus for touch-sensitive visual and audible identification according to an exemplary embodiment of the present invention. The apparatus 51 may include a display region 52 that may be similar to or the same as one of the display regions discussed above. For example, the display region 52 may be an electronic display such as an LCD, LED or OLED display device. The apparatus 51 may also include an activation switch 53 that may be similar to or the same as one of the activation switches discussed above. For example, the activation switch 53 may be a push button. When the activation switch 53 is pressed, or otherwise activated, the display region 52 may display a vocabulary word and the pronunciation of the vocabulary word may emanate from a speaking module 54. The speaking module 54 may be similar to or the same as one of the speaking modules discussed above.

A definition for the vocabulary word may then be output, in written form on the display region 52 and/or read aloud from the speaking module 54. The vocabulary word may be selected from a database of vocabulary words. The database of vocabulary words may include a text field including the spelling of the word, an audio file field including a digitized pronunciation of the word, a text field including the definition of the word, and/or an audio file field including a digitized pronunciation of the word. The database may also include a difficulty level attributed to the vocabulary word.

The vocalization of the vocabulary words and/or the definitions may either be achieved by playing the audio file fields of the database associated with the selected vocabulary word, or where such fields are not present in the database, the vocalizations may be synthesized from the text fields using available voice syntheses techniques known in the art.

The selected vocabulary word may be selected at random from the vocabulary word database, or a predetermined order may be followed. Alternatively, the selected vocabulary word may be selected according with the current date, thus allowing for a word-of-the-day function. Moreover, additional presses of the activation switch within a predetermined period of time, for example one day, may result in repetition of the same vocabulary word. Alternatively, a new word may be selected each time the activation switch 53 is activated.

The vocabulary word database may be stored on internal memory, for example, flash memory. The database may be updated by the user by connecting the apparatus to a computer, for example through a mini USB port 55. The computer may update the database with additional or replacement database entries that are provided to the computer either via a physical medium, for example a CD-ROM, or over a computer network, for example, the Internet. Alternatively or additionally, database entries may be copied to the apparatus from a removable media card, for example, an SD card that may be inserted into the apparatus via a card reader 57. In embodiments having a card reader 57, vocabulary words may be selected from a database residing on the card.

Exemplary embodiments of the present intention may include a difficulty switch 56, for example a multi-level toggle switch for allowing a user to select a desired level of difficulty. Thus when a vocabulary word is selected from the database, the desired difficulty level is determined from the state of the difficulty switch 56 and a vocabulary word with an associated difficulty level matching the selected difficulty level of the difficulty switch may be chosen.

Accordingly, a user may easily select a desired difficulty level simply by adjusting the difficulty switch. Exemplary embodiments of the present invention may therefore be simple for a user to set the desired difficulty level and simple for a user to operate. FIG. 6 illustrates example difficulty switches according to exemplary embodiments of the present invention. Example (A) shows what may be either a multi-level toggle switch or a slider switch. Example (B) shows a dial switch.

The difficulty switch may be an analog dial, for example, a potentiometer switch, that registers the desired level of difficulty within a continuous range of difficulty. Thus the level of difficulty selected by the user need not be restricted to fixed increments and the user is free to fine tune the desired difficulty.

The difficulty rating associated with each vocabulary word need not exactly match the user-selected desired difficulty in order for the vocabulary word to be selected. The user-selected desired difficulty level may indicate a desired difficulty rating and words may be selected according to their closeness to this rating. Accordingly, the user-selected desired difficulty represents a range of suitable difficulty ratings and/or the center of a distribution of suitable difficulty ratings.

For example, where difficulty ratings are attributed to each word on a scale of 1.0 to 10.0, a selected difficulty level of 7.5 may allow for the selection of a vocabulary word within a predetermined range, for example, a range of plus or minus 2.0. Thus, words with assigned difficulty levels between 5.5 and 9.5 may be randomly selected, either with equal probability, or according to their closeness to the selected difficulty level of 7.5.

Thus, the selected difficulty level may act as a center of a probability distribution where all of the vocabulary words of the vocabulary database are theoretically selectable but the probability of any given word being selected increases as its associated difficulty level approaches the selected difficulty level. Thus where the selected difficulty level is 7.5, a word having an associated difficulty level of 7.3 or 7.7 is significantly more likely to be selected than a word having an associated difficulty level of 6.8 or 8.2. The probability curve may have a Gaussian distribution.

Exemplary embodiments of the present invention may utilize the apparatus, illustrated in FIG. 5 and discussed above, to facilitate the learning of a second language. In such examples, the vocabulary words may each be words of a second-language and the corresponding definition may include a first-language translation of the second-language word.

Exemplary embodiments of the present invention may also combine the apparatus, illustrated in FIG. 5 and discussed above, with an alarm clock. Accordingly, the display region 52 may display a vocabulary word and the pronunciation of the vocabulary word may emanate from a speaking module 54 in response to a particular time of day set by the user. The user may thus use the apparatus as an alarm clock. Displays and controls may be shared between the alarm clock functionality and the functionality discussed above. For example, a single LED display may be used to display the time of day and to display the selected word and/or definition.

The above specific exemplary embodiments are illustrative, and many variations can be introduced on these embodiments without departing from the spirit of the disclosure or from the scope of the appended claims. For example, elements and/or features of different exemplary embodiments may be combined with each other and/or substituted for each other within the scope of this disclosure and appended claims.

What is claimed is:

1. An apparatus for visual and audible identification, comprising:
a display region for displaying a written name of an object;
a speaking module for pronouncing a spoken name of the object when activated;
an activation switch for activating the speaking module; and
an attachment unit for coupling the apparatus to the object.

2. The apparatus of claim 1, wherein the display region comprises a handwriting surface upon which a user hand-writes the written name of the object.

3. The apparatus of claim 2, wherein the handwriting surface is a dry-erase surface upon which a dry erase marker is used.

4. The apparatus of claim 1, wherein the display region comprises an electronic display device.

5. The apparatus of claim 1, wherein the speaking module is programmed by a user by recording the voice of the user pronouncing the spoken name of the object.

6. The apparatus of claim 1, wherein the activating switch comprises a touch-sensitive button.

7. The apparatus of claim 1, wherein the activation switch comprises a proximity sensor.

8. The apparatus of claim 1, wherein the attachment unit comprises a stand for standing the apparatus on the object.

9. The apparatus of claim 1, wherein the attachment unit comprises an adhesive layer for adhering the apparatus to the object.

10. The apparatus of claim 1, wherein the attachment unit comprises a Velcro layer for affixing the apparatus to a complementary Velcro layer attached to the object.

11. The apparatus of claim 1, wherein the attachment unit comprises a magnetic unit for attaching the apparatus to a metallic portion of the object.

12. The apparatus of claim 1, additionally comprising a memory storage unit for storing one or more written names of objects, to be displayed on the display region and one or more corresponding spoken names of the objects, to be pronounced by the speaking module when activated.

13. The apparatus of claim 1, wherein the display region is a first display region for displaying a written name of the object in a first language; and
the apparatus additionally comprises a second display region for displaying a written name of the object in a second language.

14. The apparatus of claim 1, wherein a body of the apparatus is primarily comprised of a laminated paper stock that functions as the display region and includes a handwriting surface upon which a user hand-writes the written name of the object.

15. An apparatus for visual and audible association, comprising:
a database for storing a plurality of words along with corresponding definitions of the words and associated difficulty levels;
a difficulty switch having a plurality of states representing a desired word difficulty level;
a processing unit for selecting a word from the database based on the state of the difficulty switch;
a display device for displaying the selected word when activated;
a speaking module for pronouncing the selected word when activated; and
an activation switch for activating the display device and the speaking module.

16. The apparatus of claim 15, wherein the display device additionally displays the corresponding definition of the selected word when activated.

17. The apparatus of claim 15, wherein the speaking module additionally pronounces the corresponding definition of the selected word when activated.

18. The apparatus of claim 15, wherein the difficulty switch is an analog switch that is set to any position within a continuous range.

19. The apparatus of claim 15, wherein the difficulty switch is a multi-level toggle switch, a dial switch or a slider switch.

20. The apparatus of claim 15, wherein the selection of the selected word from the database comprises:
reading the state of the difficulty switch; and
selecting the selected word based on a degree of similarity between the state of the difficulty switch and the associated difficulty level of the plurality of words stored in the database;
wherein the probability of a particular word being selected increases as the degree of similarity between the state of the difficulty switch and the associated difficulty level of the particular word being selected increases.

21. A method for teaching an association between an object and a written name of the object, the method comprising:
displaying the written name of the object within a display region of an apparatus;
coupling the apparatus to the object by an attachment unit; and
presenting the object and coupled apparatus to an observer who simultaneously observes the object and the displayed written name of the object on the apparatus.

22. The method of claim 21, additionally comprising activating a speaking module to pronounce a spoken name of the object.

23. The method of claim 21, wherein the step of displaying the written name of the object within the display region of the apparatus includes hand-writing the written name of the object on a handwriting surface of the display region.

24. The method of claim 21, additionally comprising:
programming a speaking module of the apparatus by recording a pronunciation of a spoken name of the object, prior to the step of presenting the object and coupled apparatus to the observer; and
activating the speaking module to replay the recorded pronunciation of the spoken name of the object, after the step of presenting the object and coupled apparatus to the observer.
